(19) United States
(12) Patent Application Publication
(10) Pub. No.: US 2026/0249718 A1
(43) Pub. Date: Aug. 27, 2026

(54) CHARGING DEVICE FOR CHARGING A VEHICLE BATTERY AND METHOD FOR OPERATING THE CHARGING DEVICE

(71) Applicant: Robert Bosch GmbH, Stuttgart (DE)

(72) Inventors: Andreas Schoenknecht, Renningen (DE); Christoph Van Booven, Bietigheim-Bissingen (DE); Thomas Kopp, Ostfildern (DE)

(21) Appl. No.: 19/133,295

(22) PCT Filed: Oct. 5, 2023
(86) PCT No.: PCT/EP2023/077536

§ 371 Date: May 28, 2025

(30) Foreign Application Priority Data
Nov. 28, 2022 (DE) 10 2022 212 673.4

(51) Int. Cl. B60L 53/22; B60L 50/60; B60L 53/14

(52) U.S. Cl. CPC B60L 53/22; B60L 50/60; B60L 53/14; B60L 2210/10

(57) ABSTRACT

The invention relates to a charging device for charging a vehicle battery, comprising an input circuit (200) for providing a DC voltage to a two-pole intermediate connection (300) and comprising a bi-directional DC-DC converter (450) which is designed to provide a charging voltage to a high-voltage network (400) which can be connected to the output side of the DC-DC converter (450), wherein a circuit unit (402) for generating an internal supply voltage for the control unit (452) for the charging device (500) is connected on the output side of the DC-DC converter (450), in order to supply the control unit (452) from the connectable high-voltage network (400).

### BACKGROUND

The invention relates to a charging device for charging a vehicle battery and a method for operating the charging device. Furthermore, the invention relates to a drive train with a charging device, a vehicle with a drive train as well as a computer program and a computer-readable storage medium.

Charging devices for a vehicle or method for operating a charging device, for example in vehicles with an electric drive in an electric vehicle or a hybrid vehicle, are used to recharge batteries, preferably accumulators or traction batteries, from an electrical energy source, preferably an external alternating current source or the public alternating current grid. To this end, the charging device converts a sinusoidal alternating voltage current of the external power source to a direct voltage current.

Preferably, charging devices have two-stage power electronics. A first stage, the so-called power-factor-correction stage, the PFC stage, converts the sinusoidal input voltage from the alternating voltage power grid into a direct voltage. A second stage consists of a direct voltage converter or DC/DC converter that ensures galvanic isolation via a transformer and adjusts the voltage levels. Preferably, the output voltage and/or the output current for charging the battery is adjusted by means of an electric circuit and a controller. An intermediate capacitor is arranged between the two stages, which buffers the power pulsation in the double frequency of the alternating voltage current of the power source. This DC link may be realized by means of at least one electrolyte capacitor. These topologies allow for the maintenance of a near sinusoidal input current on the power grid side to meet power grid-side standards, a galvanic isolation between the power grid and vehicle to meet safety requirements, and a constant direct voltage output current on the side of the battery to minimize the load on the battery during charging.

In an electric drive vehicle, the battery is further connected to an inverter to supply energy to the electric drive machine. A DC-DC converter is connected in parallel to the inverter to supply a low-voltage network, or an on-board power supply, of the vehicle to supply the control devices with energy. Not least to prevent electromagnetic interference, a consumer in a high-voltage network, such as an inverter, a DC/DC converter or a DC voltage converter, comprises capacitors between the high-voltage connections that filter out rapid changes in the high-voltage voltage that occur during operation.

In the event of an accident or before carrying out repairs on the vehicle, the electrical charge in the capacitors of the vehicle's high-voltage or high-voltage electrical system must be reliably discharged so that there is no risk of injury to persons if they touch or come into contact with cables or components of the high-voltage electrical system. As is disclosed in publication EP 2 516 197 B1, corresponding discharge circuits are usually provided in a decentralized manner in individual components of the high-voltage network, e.g., in inverters. The discharge circuits comprise additional components for this purpose, which increase the required installation space and weight. There is therefore a need for solutions that at least partially centralize such discharge circuits, partially or completely replace them, or accelerate the discharge of the high-voltage network.

### SUMMARY

The present invention provides a charging device for charging a vehicle battery. The charging device comprises, on the input side, an input connection unit for connecting a single-phase or multiphase AC voltage with n phases, wherein n is greater than or equal to 1, and an input circuit connected thereto for providing a DC voltage to at least a two-pole intermediate connection. Such an input circuit comprises a rectifier circuit for converting the AC voltage on the input side into a DC voltage on the output side. Preferably, the input circuit also comprises a PFC stage. A preferred topology for such an input circuit is a 3L TNPC, a Vienna rectifier or a (totem pole) PFC circuit. At least one intermediate capacitor is connected between the positive intermediate connection and the negative intermediate connection. A bi-directional DC-DC converter is connected to the intermediate connection on the input side. The bi-directional DC-DC converter is configured to convert the DC voltage applied to the intermediate connection into a charging voltage during charging mode and to supply it to a high-voltage network connectable to the output side of the DC-DC converter, preferably to a connectable battery. The high-voltage network, or a consumer connected to the high-voltage network, comprises at least one high-voltage capacitor connected between the potentials of the connectable high-voltage network. The charging device further comprises a control unit which is configured to control the bi-directional DC-DC converter. Preferably, the control comprises the regulation of the bi-directional DC-DC converter, the control of the power switches of the DC-DC converter and/or the performance of diagnostics and diagnostic procedures of the DC-DC converter. A circuit unit for generating an internal supply voltage for the control unit is connected or switched on the output side of the DC-DC converter. The internal supply voltage is preferably an operating voltage for the control unit. The internal supply voltage preferably corresponds to a vehicle's on-board network voltage and is, for example, 5.12, 24, or 48 volts. Preferably, the internal supply voltage provides redundancy for an external supply voltage. Preferably, the electrical parameters of the internal supply voltage correspond to those of a possible external supply voltage. The circuit unit is configured to supply the control unit from the connectable high-voltage network. Preferably, the circuit unit is configured to supply the control unit from the connectable high-voltage network in a discharge mode. Accordingly, the energy from the high-voltage network is used to generate the internal supply voltage by means of the circuit unit for the control unit in order to discharge the capacitances in the high-voltage network.

The charging device preferably comprises a terminal connection for connecting an external supply voltage in order to supply the control unit in the charging device. Preferably, the external supply voltage is an operating voltage for the control unit. The external supply voltage preferably corresponds to an on-board voltage of a vehicle and is, for example, 5.12, 24 or 48 volts.

This provides a charging device comprising a circuit unit which generates an internal supply voltage for the control unit of the charging device from an electrical charge applied to the DC-DC converter on the output side. Consequently, the circuit unit is designed to supply the control unit from the connectable high-voltage network. In this process, an electrical charge applied to the DC-DC converter on the output side is at least partially reduced, or charge-storing capacitances, preferably from the connectable high-voltage network, are discharged. It is preferred that the applied electrical charge is stored in at least one capacitance, in a high-voltage capacitor of the connectable high-voltage network or in at least one capacitance of a component of the connectable high-voltage network. Preferably, the control unit is supplied in a discharge mode by means of the circuit unit for discharging the electrical charge applied to the output side of the DC-DC converter. The control unit is supplied from the electrical charge applied to the output side of the DC-DC converter. This is preferably done in response to a signal or error signal that requests the discharge of the high-voltage components of the charging device or the high-voltage network. This signal is preferably determined within the charging device or by an external control device of the vehicle and received by the charging device, preferably the control unit. Preferably, this signal is determined, generated and sent depending on a malfunction, an error in the region of the external supply voltage, a short circuit, an insulation fault, a diagnosis, the performance of a repair, the vehicle being switched off or parked, or the detection that a plug, preferably a signal plug, is not connected to the charging device In a discharge mode, the control unit controls the DC-DC converter such that the charge present on the output side is transported in the direction of the intermediate connection and thus the intermediate capacitor is charged. To ensure functionality even in the event of a fault in the region of the external supply voltage, preferably at the terminal connection, the control unit of the charging device is supplied in discharge mode via the circuit unit from the electrical charge applied to the output side of the DC-DC converter by means of the internal supply voltage.

Advantageously, a charging device is provided which enables reliable discharging of the capacitances or capacitors of a high-voltage network connected to the charging device. For this purpose, in discharge mode, the charge applied to the output side is transferred to the input side by reverse operation of the bi-directional DC-DC converter of the charging device, thereby charging the intermediate capacitor. In addition, the provision of an internal supply voltage increases the reliability of the charging device, preferably for discharge mode.

An external energy source is preferably a single-phase or multiphase, preferably three-phase, alternating voltage network, preferably the public low-voltage network, preferably for supplying households, industry, and/or infrastructure. Preferably, in a North American region or Japanese region, this is a 120 or 240 volt single-phase alternating voltage network. Preferably, in a Chinese or European region, this is a three phase alternating voltage power system of about 230 Volts. For charging mode of the charging device, the charging device should preferably be connected to a suitable AC voltage supply via the n-phase input connection unit or connected to the appropriate AC voltage. Preferably, the n-phase input connection unit comprises a neutral terminal for connecting a neutral conductor of the alternating voltage power system to be connected. Preferably, a battery to be charged is an accumulator or a traction battery by means of which energy is supplied to an electric drive train of a vehicle. A rectification circuit is preferably a rectifier for converting the alternating voltage current into a direct voltage current. A high side switch or a low side switch of a semiconductor bridge is preferably a power semiconductor switch comprising an intrinsic diode, preferably an IGBT or MOSFET, preferably based on Si, SiC or GaN technology. Preferably, the expression connecting, for example, a center pickup to a connecting line, means contacting or connecting the components by means of an electrically conductive line or a galvanic connection. The expression blocking, preventing, decoupling or preventing a current flow means disconnecting an electrically conductive line or connection. Preferably, the expression “switched” is used synonymously with “electrically connected,” wherein “switchably connected” means that an electrical connection can be established or disconnected, preferably by means of a switch or switching element. Preferably, the expression arranged is used to define the position of an electrical component, preferably a switch or switching element, within the circuit topology, comprising an electrical connection to the adjacent electrical components.

In one embodiment, the circuit unit is operated to generate an internal supply voltage when the connectable external supply voltage is not available.

There are various reasons why the connectable external supply voltage may not be available. For example, there may be a fault in the vehicle's on-board electrical system, the power supply in the on-board electrical system may be disrupted, or the cable or plug connection may be mechanically damaged. Operating the circuit unit has the advantage of increasing the reliability and availability of the charging device's discharge function.

In one embodiment, the circuit unit for generating an internal supply voltage comprises a circuit for generating at least one auxiliary voltage. Preferably, the auxiliary voltage is used to supply the control unit of the charging device, preferably the control unit for controlling the DC-DC converter. Preferably, a plurality of auxiliary voltages are generated to supply the different voltage consumers within the charging device, preferably controller circuits, driver circuits, the power switches of the charging device or diagnostic circuits.

A charging device with a circuit unit for supplying at least one control unit is advantageously provided.

In one embodiment, the circuit unit for generating the internal supply voltage comprises at least one, preferably potential-separated, second DC-DC converter.

A charging device with a circuit unit that enables safe operation of the vehicle is advantageously provided.

In one embodiment, the bi-directional DC-DC converter comprises at least one LLC, CLLC, or dual active bridge circuit. A circuit topology of the bi-directional DC-DC converter with or without galvanic isolation can also be used depending on the boundary conditions of the application.

Suitable circuit types for use in a bi-directional DC-DC converter are advantageously provided.

Furthermore, the invention relates to a drive train of a vehicle with a charging device as described above, wherein the drive train comprises in particular a traction battery, an inverter and/or an electrical machine.

An advantage is provided by a drive train of an electric vehicle with a charging device which is configured to discharge the capacitances or capacitors of the high-voltage network connected to the charging device by means of the charging device in a discharge mode.

The invention also relates to a vehicle with a drive train as described above.

Advantageously, a vehicle with an electrified drive train with improved discharge functionality is provided.

Furthermore, the invention relates to a method for operating the charging device. This method comprises the step of: operating the circuit unit for generating an internal supply voltage during a discharge mode.

Preferably after receiving a signal or error signal for discharging the electrical charge applied to the DC-DC converter on the output side, the circuit unit supplies the control unit with electrical energy. Preferably, the DC-DC converter is then controlled by the control unit in a discharge mode such that the charge applied to the output is transported in the direction of the intermediate connection and the intermediate capacitor is charged.

Advantageously, a method for operating the charging device is provided which enables central discharging of the capacitances or capacitors of a high-voltage network connected to the charging device. For this purpose, the charge is first transferred from the high-voltage network to the intermediate capacitor.

The invention further relates to a computer program comprising commands which, when the program is executed by a control unit, cause it to carry out the method described.

The invention also relates to a computer-readable storage medium comprising commands which, when executed by a control unit, cause it to carry out the method described.

It is understood that the features, properties, and advantages of the charging device apply or can be applied accordingly to the method or the drive train and the vehicle and vice versa.

### BRIEF DESCRIPTION OF THE DRAWINGS

Further features and advantages of embodiments of the invention are apparent from the following description with reference to the accompanying drawings.

The invention will be explained in further detail hereinafter with reference to the drawings:

FIG. 1 a schematic illustration of an embodiment of a circuit topology for a charging device with a control unit.

FIG. 2 a schematic illustration of a vehicle comprising a drive train with a charging device,

FIG. 3 a schematic illustration of a flowchart for a method for operating a charging device.

### DETAILED DESCRIPTION

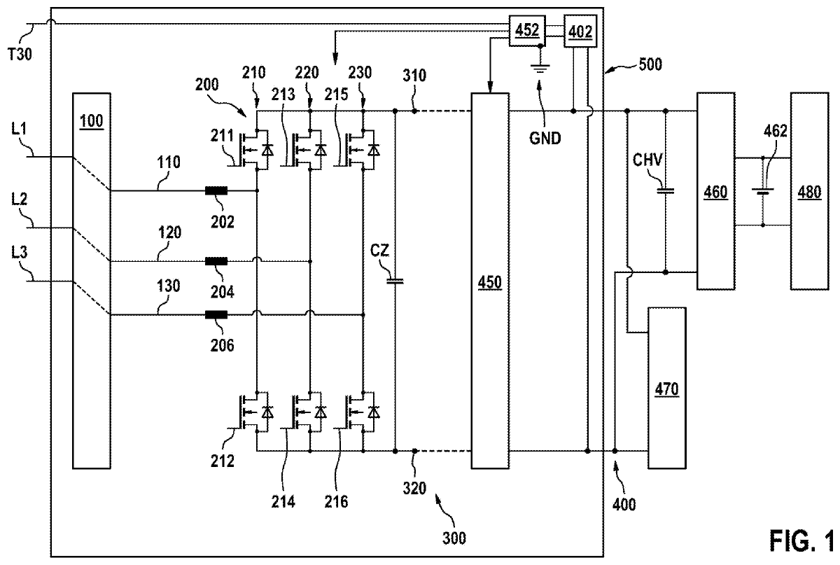

FIG. 1 shows a charging device 500, preferably for charging a vehicle battery. The charging device 500 comprises, on the input side, an input connection unit 100 for connecting an exemplary three-phase alternating voltage, an input circuit 200 for providing a direct voltage to at least a two-pole intermediate connection 300. At least one intermediate capacitor CZ is connected between the positive intermediate connection 310 and the negative intermediate connection 320. A bi-directional DC-DC converter 450 is also connected to the intermediate connection 300. The DC voltage at the intermediate connection 300, which is applied to the input side of the DC-DC converter 450, is converted into a charging voltage in a charging mode and made available on the output side of the DC-DC converter 450 to provide a high-voltage network 400 connectable on the output side to the DC-DC converter 450 and/or to charge a battery 470 connectable on the output side of the DC-DC converter 450, preferably a traction battery or high-voltage battery. The high-voltage network 400 comprises at least one high-voltage capacitor CHV, a capacitance in the high-voltage network 400. The high-voltage capacitor CHV is shown as an example for at least one of the capacitances of the components connected to the high-voltage network 400. Preferably, the high-voltage network 400 comprises several consumers. Preferably, a third DC-DC converter 460, preferably a step-down converter, is connected in parallel to the battery 470 to convert the charging voltage into a low voltage for charging a low-voltage battery 462 and for supplying a vehicle on-board electrical system for supplying the control devices of a vehicle. The low-voltage battery 462, as well as other low-voltage consumers 480, are connected to the vehicle's on-board electrical system.

In the event of an accident or before carrying out repairs on the vehicle, the capacitances or capacitors of the consumers connected to the high-voltage network 400 or of the high-voltage network or high-voltage network of the vehicle must be reliably discharged. This reliably prevents any danger to persons that could arise from touching or coming into contact with lines or components of the high-voltage electrical system. According to the invention, a circuit unit 402 is connected to the output side of the DC-DC converter 450 to generate an internal supply voltage for a control unit 452 for the charging device 500. This makes it possible for the control unit 452 to be supplied from the connectable high-voltage network 400. The controls of the charging device 500, in particular the control unit 452, can be supplied exclusively by means of the circuit unit 402. Preferably, the circuit unit additionally comprises an energy storage device, preferably a capacitor or a battery (not shown), which is charged directly from the high-voltage network 400. Alternatively, the control unit 452 is supplied by an external supply voltage, which can preferably be provided via a terminal connection T30. Preferably, a terminal connection T30 is connected to the on-board electrical system of the vehicle via a plug or signal connector and preferably supplies the control unit 452 with an external supply voltage, preferably an on-board voltage of the vehicle. However, the control unit 452 can also be supplied from the connectable high-voltage network 400 if an external supply voltage is not available, preferably due to a fault. The preferably additional or redundant circuit unit 402 thus ensures a reliable supply to the control unit 452 for discharging as long as a high-voltage network 400 to be discharged is connected to the charging device 500. The DC-DC converter 450 is operated by the control unit 452 in a discharge mode in such a way that the charge applied to the output side of the high-voltage network 400, preferably from the high-voltage capacitor CHV, is transported in the direction of the intermediate connection 300 and the intermediate capacitor CZ is charged. Preferably, the control unit 452 receives or determines a signal, preferably an error signal, whereupon the control unit 452 discharges the electrical charge applied to the output side of the DC-DC converter 450 by means of the discharge mode. Preferably, the charging device comprises a first measuring device (not shown in FIG. 1 for clarity), which is configured to determine a first measured value that characterizes the voltage applied to the output side of the DC-DC converter 450. This could be a first measuring device for directly determining the voltage on the output side of the DC-DC converter. Alternatively, one or more measuring devices for determining one or more electrical parameters (current, voltage) on the input and/or output side of the DC-DC converter and an adapted calculation could be used to determine or characterize the voltage applied to the output side of the DC-DC converter 450 as a first measured value. Similarly, a corresponding first measured value or the voltage value can be transmitted to the control unit 452, preferably by means of a bus system from a component of the high-voltage network or on-board electrical system of the vehicle. Preferably, the charging device comprises a second measuring device (not shown in FIG. 1 for reasons of clarity) which is configured to determine a second measured value characterizing a voltage applied to the two-pole intermediate connection 300. This could be a second measuring device for directly determining the voltage at the two-pole intermediate connection 300. Alternatively, one or more measuring devices for determining one or more electrical parameters (current, voltage) could be used on the input and/or output side of the charging device 500 and, by means of an adapted calculation, the voltage applied to the two-pole intermediate connection 300 could be determined or characterized as a second measured value. Similarly, a corresponding second measured value or the voltage value can be transmitted to the control unit 452, preferably by means of a bus system from a component of the high-voltage network or on-board electrical system of the vehicle. Preferably, the control unit 452 is configured to control the DC-DC converter 450 such that, in a first step, the charge is first transferred from the connectable high-voltage network 400 to the intermediate capacitor CZ and then, in a second step, back to the high-voltage capacitor CHV. When the two steps are performed, the amount of charge stored in the high-voltage network 400 is reduced because the transfer of charge through the DC-DC converter 450 is sufficiently lossy. Preferably, the DC-DC converter 450 is controlled during at least one of the two steps in the discharge mode such that the losses of the DC-DC converter 450 are greater than in the charge mode, which These two steps are repeated in succession until the high-voltage capacitor CHV or the high-voltage network 400 is discharged to such an extent that there is no danger to persons if the live components, preferably the high-voltage network 400, are touched. The first and second measured values are determined as abort criteria for the first and second steps and compared with prespecified first and second threshold values. The first and second threshold values are set lower with each repetition so that a significant discharge of the system consisting of the charging device and the high-voltage network occurs when a first or second step is performed. As an abort criterion for the entire discharge process, a third measured value is determined in the same way as the first measured value and compared with a prespecified third threshold value. The third threshold value is specified such that there is no danger to persons if the live components, preferably the high-voltage network, are touched. The abort criterion for the entire charging process is preferably selected so that a value derived from the relevant international standards for high-voltage safety is guaranteed in the event of an abort.

In one embodiment, the discharging comprises the further step of:
discharging the intermediate capacitor by means of a discharge circuit. Preferably, the intermediate capacitor is discharged by connecting parasitic resistors or a discharge resistor to it. An advantageous method is provided which enables the capacitance or capacitors of a high-voltage network connected to the charging device to be discharged centrally. To this end, the charge is first transferred from the high-voltage network to the intermediate capacitor, which is discharged by means of a discharge circuit. Preferably, this discharge of the intermediate capacitor can also take place in parallel with the steps for discharging the high-voltage network and/or feeding the charge back into the high-voltage network, thereby advantageously accelerating the process. The discharge methods presented can preferably be combined with other discharge methods, preferably with current pulses from power semiconductors or by shifting charge from the high-voltage network to storage devices that can be galvanically disconnected from the high-voltage network, thereby ruling out any risk to persons.

An exemplary input circuit 200, an exemplary PFC stage, of the charging device 500 comprises a first 210, a second 220 and a third 230 half-bridge. The first, second, and third half-bridges 210, 220, 230 each comprise a series connection having a high-side switch 211, 213, 215 and a low-side switch 212, 214, 216. One center tap between the high-side switch and the low-side switch of a half bridge is connected via a first, second and third inductor 202, 204, 206, each having a first, second and third input connection L1, L2, L3 of the input connection unit 100, via a first, second and third connection line 110, 120, 130. Thus, the center pickup of the first half-bridge 210 can be connected via the first inductor 202 to the first input connection LI via the first connecting line 110. Thus, the center pickup of the second half-bridge 220 can be connected via the second inductor 204 to the second input connection L2 via the second connecting line 120. Thus, the center pickup of the third half-bridge 230 can be connected via the third inductor 206 to the third input connection L3 via the third connecting line 130. The half-bridges 210, 220, 230 are connected in parallel. Their ends are connected to the two-pole intermediate connection 300. The high-side switches are connected to a positive intermediate connection 310 and the low-side switches are connected to a negative intermediate connection 320.

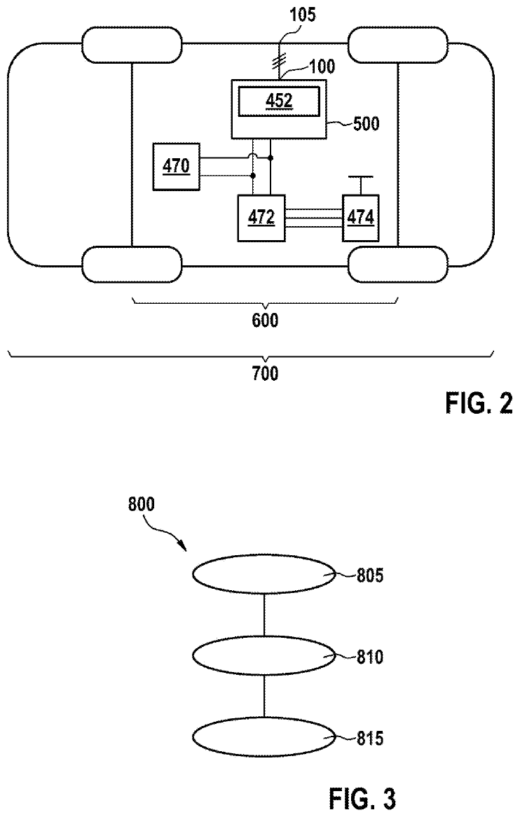

FIG. 2 shows a schematic illustration of a vehicle 700 comprising a drive train 600 with a charging device 500. The input connection unit 100 of the charging device 500 is preferably connectable to an external energy source via an electrical connection via a charger connection 105. Preferably, an external power source is connected to the charger connection 105 via a wall box. This connection is preferably used for charging mode. However, a feedback operation is also possible, in which energy from the battery 470 is fed back to the external power source. The vehicle 700 is shown here only as an example with four wheels, wherein the invention is equally applicable in any vehicles with any number of wheels on land, on water, and in the air. The exemplary drive train 600 comprises at least one charging device 500 with a control unit 452. The charging device 500 comprises a circuit unit 402 (not shown in this figure) for generating an internal supply voltage for the control unit 452. The drive train preferably further comprises a battery 470, an inverter 472 and/or an electric machine 474. Any further consumers are preferred, which preferably comprise further capacitances between the high-voltage connections, are connected to the high-voltage network 400 of the drive train 600. The charging device 500 is shown here within the vehicle by way of example only. The charging device may also be designed as a stand-alone charging device 500, preferably as a charging station or wall box, and located outside a vehicle.

FIG. 3 shows a schematic flowchart for a method 800 for operating a charging device 500. The method 800 starts with step 805. In step 810, the circuit unit 402 is operated to generate an internal supply voltage for a discharge mode. For this purpose, the circuit unit 402 is controlled accordingly, preferably corresponding circuit devices within the circuit unit 402 are closed. Preferably, the circuit unit 402 is operated to generate an internal supply voltage when a connectable external supply voltage is not available. The method ends at step 815.

1. A charging device for charging a vehicle battery, wherein the charging device (500) comprises, on the input side, an input connection unit (100) for connecting a single-phase or multiphase AC voltage with n phases, wherein n is greater than or equal to 1, and an input circuit (200) for providing a DC voltage at a two-pole intermediate connection (300),
wherein an intermediate capacitor (CZ) is connected between the positive intermediate connection (310) and the negative intermediate connection (320),
wherein a bi-directional DC-DC converter (450) is connected on the input side to the intermediate connection (300), which is configured to convert the DC voltage applied to the intermediate connection (300) into a charging voltage in a charging mode and to provide it to a high-voltage network (400) connectable to the output side of the DC-DC converter (450),
wherein the charging device (500) comprises a control unit (452) for controlling the bi-directional DC-DC converter (450), and wherein
a circuit unit (402) is connected on the output side of the DC-DC converter (450) for generating an internal supply voltage for the control unit (452) for the charging device (500), to supply the control unit (452) from the connectable high-voltage network (400).

2. The charging device according to claim 1, wherein the circuit unit (402) for generating an internal supply voltage is operated when a connectable external supply voltage is not available.

3. The charging device according to claim 1, wherein the circuit unit (402) for generating an internal supply voltage comprises a circuit for generating at least one auxiliary voltage.

4. The charging device according to claim 1, wherein the circuit unit (402) for generating the internal supply voltage comprises at least one potential-separated second DC-DC converter.

5. A drive train (600) of a vehicle (700) having a charging device (500) according to claim 1, wherein the drive train (600) comprises a traction battery (470), an inverter (472), and/or an electrical machine (474).

6. A vehicle (700) having a drive train (600) according to claim 5.

7. A method (800) for operating a charging device according to claim 1,
with the following step:
operating (810) the circuit unit (402) for generating an internal supply voltage during a discharge mode.

8. (canceled)

9. A non-transitory, computer-readable storage medium comprising instructions which, when executed by a control unit (452), prompt the control unit to operating a charging device that includes,
an input connection unit (100) for connecting a single-phase or multiphase AC voltage with n phases, wherein n is greater than or equal to 1, and an input circuit (200) for providing a DC voltage at a two-pole intermediate connection (300),
an intermediate capacitor (CZ) connected between the positive intermediate connection (310) and the negative intermediate connection (320),
a bi-directional DC-DC converter (450) connected on the input side to the intermediate connection (300), which is configured to convert the DC voltage applied to the intermediate connection (300) into a charging voltage in a charging mode and to provide it to a high-voltage network (400) connectable to the output side of the DC-DC converter (450),
wherein the charging device (500) comprises a control unit (452) for controlling the bi-directional DC-DC converter (450), and
a circuit unit (402) connected on the output side of the DC-DC converter (450) for generating an internal supply voltage for the control unit (452) for the charging device (500), to supply the control unit (452) from the connectable high-voltage network (400)
by:
operating (810) the circuit unit (402) for generating an internal supply voltage during a discharge mode.
